(19) United States
(12) Patent Application Publication
(10) Pub. No.: US 2007/0058186 A1
(43) Pub. Date: Mar. 15, 2007

(54) Image Processing Apparatus, Image Processing Method, Image Processing Program, And Storage Medium

(75) Inventor: Mitsuharu Tanaka, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/530,527

(22) Filed: Sep. 11, 2006

(30) Foreign Application Priority Data
Sep. 12, 2005 (JP) 2005-264438

(51) Int. Cl. H04N 1/60

(52) U.S. Cl. 358/1.9

(57) ABSTRACT

A spectral reflectance storage unit stores spectral reflectance data on each of a plurality of predetermined colors; spectral distribution data storage contains spectral distribution data on a light source; an arithmetic unit determines XYZ values of each of the colors under specified viewing conditions, based on the spectral distribution data of the light source under the viewing conditions as well as on the spectral reflectance data on each of the colors, the spectral distribution data stored in the spectral distribution data storage; and a profile dependent on the viewing conditions is created based on the XYZ values of the colors obtained by the arithmetic unit.

### BACKGROUND OF THE INVENTION

1. Field of the Invention

The present invention relates to an image processing apparatus, image processing method, image processing program, and storage medium which create profiles for use to perform color matching according to ambient light.

2. Description of the Related Art

FIG. 13 is a conceptual diagram illustrating typical color matching.

RGB input data 1300 is converted into XYZ data 1302, which is device-independent color space data, by a converter 1301. Colors out of a reproducible color gamut of an output device cannot be expressed by the output device. Thus, the converted data is subjected to color space compression to become device-independent color space data so that all colors of the converted data will fall within the reproducible color gamut (1303). After the color space compression, the device-independent color space data is converted into CMYK data in a device-dependent color space (1304).

In typical color matching, a reference white point and ambient light (D50) are fixed. For example, in profiles prescribed by the International Color Consortium (ICC), profile connection space (PCS) 1305 which connect profiles is given by D50-based XYZ and Lab values. This ensures correct color reproduction when an input document or print output is viewed under a D50 light source (1306, 1307). Under a light source of other characters, correct color reproduction is not ensured. A technique which solves this problem with typical conventional color matching processes is described in Japanese Patent Laid-Open No. 2000-50086 (Document 1).

The invention described in Document 1 enables good color matching regardless of viewing conditions such as ambient light. Furthermore, the invention stores XYZ values for a plurality of standard sources in a single profile and determines XYZ values for viewing conditions using XYZ values for the standard source closest to the viewing conditions. This makes it possible to perform color matching with higher accuracy according to viewing conditions.

However, the image processing method described in Document I is based on the assumption that XYZ values for a plurality of standard sources are stored in a single profile. Thus, it is necessary to take as many color measurements as there are standard light sources to be stored.

### SUMMARY OF THE INVENTION

An object of the present invention is to solve the technical problems described above.

The feature of the present invention is to provide a technique for increasing the efficiency of creating profiles according to viewing conditions.

According to the present invention, there is provided an image processing apparatus for creating a profile for color matching, comprising:

a viewing condition setting unit configured to set viewing conditions to which the profile is applied;

a spectral reflectance storage unit configured to store spectral reflectance data on each of a plurality of predetermined colors;

a spectral distribution storage unit configured to store spectral distribution data on a light source;

an arithmetic unit configured to determine XYZ values of each of the colors under the viewing conditions, based on the spectral distribution data of the light source under the viewing conditions set by the viewing condition setting unit as well as on the spectral reflectance data on each of the colors, the spectral distribution data being stored in the spectral distribution storage unit;

a profile creation unit configured to create a profile dependent on the viewing conditions, based on the XYZ values of the colors obtained by the arithmetic unit; and

a control unit configured to ensure that the arithmetic unit and the profile creation unit create a profile for each set of viewing conditions, in a case where multiple sets of viewing conditions are set by the viewing condition setting unit.

Further, according to the present invention, there is provided an image processing method for creating a profile for color matching, comprising:

a viewing condition setting step of setting viewing conditions to which the profile is applied;

an arithmetic step of determining XYZ values of each of a plurality of predetermined colors under the viewing conditions set in the viewing condition setting step, based on spectral reflectance data on each of the colors as well as on spectral distribution data on a light source under the viewing conditions;

a profile creation step of creating a profile dependent on the viewing conditions, based on the XYZ values of the colors obtained in the arithmetic step; and

a control step of causing the arithmetic step and the profile creation step to create a profile for each set of viewing conditions, in a case that multiple sets of viewing conditions are set in the viewing condition setting step.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an example of functional configuration of a profile creation apparatus and color conversion apparatus according to an embodiment of the present invention;

FIG. 2 is a conceptual diagram illustrating a concept of a color management system according to the embodiment;

FIG. 3 is a block diagram illustrating a hardware configuration of the profile creation apparatus and color conversion apparatus according to the embodiment;

FIGS. 4A and 4B are block diagrams showing spectral distributions of standard light source;

FIG. 5 is a diagram showing a concept of a color matching process;

FIG. 6 is a diagram showing an example of a user interface of the profile creation apparatus according to the embodiment;

FIG. 7 is a diagram showing an example of a user interface displayed by a color matching application on the color conversion apparatus according to the embodiment;

FIG. 8 is a flowchart illustrating a start-up process of the profile creation apparatus according to the embodiment;

FIG. 9 is a flowchart illustrating a profile creation process by a profiler according to the embodiment;

FIG. 10 is a diagram illustrating a color appearance model used in the embodiment;

FIG. 11 is a conceptual diagram illustrating a concept of a color management system according to a variation of the embodiment;

FIG. 12 is a conceptual diagram illustrating a concept of a color management system according to another variation of the embodiment; and

FIG. 13 is a conceptual diagram illustrating typical color matching.

### DESCRIPTION OF THE EMBODIMENTS

A preferred embodiment of the present invention will now be described in detail with reference to the accompanying drawings. It should be noted that the embodiment below does not limit the present invention set forth in the claims and that not all of the combinations of features described in the embodiment are necessarily essential as means for the solution by the invention.

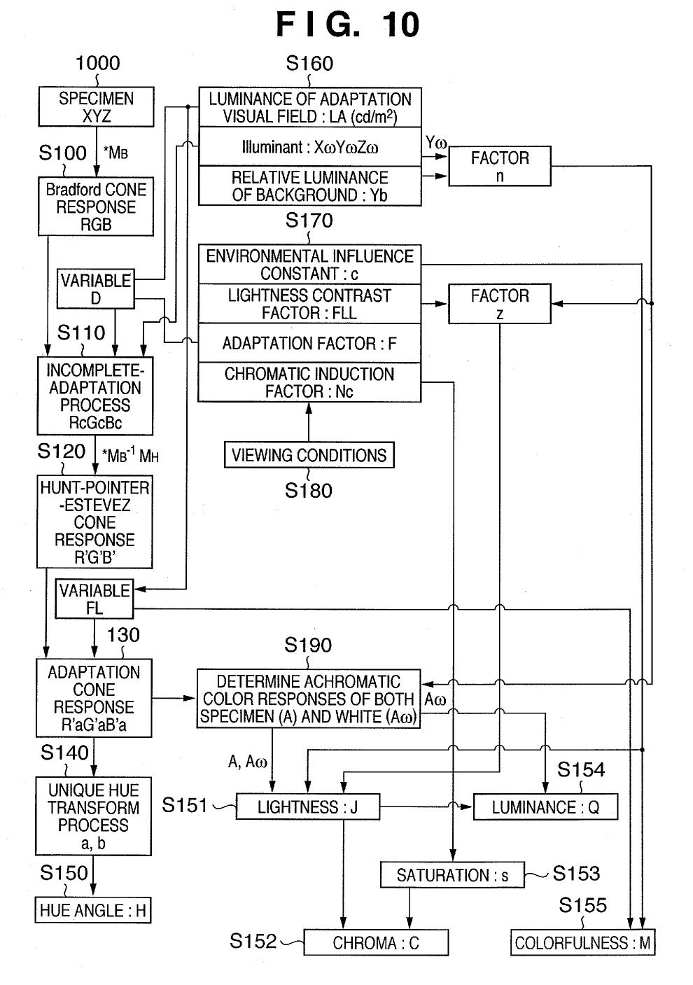

First, with reference to FIG. 10, description will be given of a color appearance model used in the embodiment described below.

FIG. 10 is a diagram illustrating a color appearance model used in the embodiment.

It is known that even if the same light enters the eye, a color perceived by the human visual system varies with the illuminating light, background, and other conditions. For example, a white color illuminated by an incandescent lamp does not appear so red as it should appear according to properties of the light entering the eye, but it is perceived as white. Also, white against a black background appears brighter than white against a light background. The former phenomenon is known as chromatic adaptation while the latter phenomenon is known as color contrast. Thus, it is necessary to describe colors based on amounts corresponding to physiological activity of photoreceptor cells distributed on the retina instead of XYZ values. Color appearance models have been developed for this purpose. The CIE recommends the use of CIE CAM97s. This perception model uses physiological primary colors of chromatic vision. For example, values of H (hue), J (lightness), and C (chroma), or values of H (hue), Q (brightness), and M (colorfulness), which are amounts of correlation in color perception calculated based on CIE CAM97s, are considered to provide a display method of colors independent of viewing conditions. By reproducing colors in such a way that the values of H, J, and C, or values of H, Q, and M will agree among devices, it is possible to solve the problem caused by differences in viewing conditions of input/output images.

Process details of a forward transform of a CIE CAM97s color appearance model on which a correction process (the process of converting XYZ into HJC or HQM) is performed according to viewing conditions for viewing an input image will be described with reference to FIG. 10.

First, viewing condition information about viewing conditions of an input image is set in S160. The viewing condition information includes LA (cd/m2) which is luminance of an adaptation visual field (normally 20% of white in the adaptation visual field), XYZ values which are relative tristimulus values of a specimen under light source conditions, XωYωZω which is relative tristimulus values of white light under light source conditions, and Yb which is relative luminance of a background under light source conditions. Also, in S170, viewing condition information of the input image is set based on viewing conditions specified in S180. The viewing condition information includes an environmental influence constant c, chromatic induction factor Nc, lightness contrast factor FLL, and adaptation factor F. Based on the viewing condition information about the input image set in S160 and S170, the following processes are performed on the XYZ values 1000 which represent the input image.

In S100, Bradford cone response RGB values are determined by converting the XYZ values based on Bradford's three primary colors considered to be physiological primary colors of man. Human vision does not always adapt completely to a viewing light source. Thus, in S110, a variable D which represents a degree of adaptation is determined based on the luminance level and ambient conditions (LA and F), and RGB values are converted into RcGcBc through an incomplete-adaptation process based on the variable D and the relative tristimulus values XωYωZω of white light.

In S120, Hunt-Pointer-Estevez cone response R′G′B′ are determined by converting RcGcBc based on Hunt-Pointer-Estevez's three primary colors considered to be physiological primary colors of man. Next, in S130, post-adaptation cone response R′aG′aB′a according to both specimen and white are determined by estimating the degree of adaptation to the R′G′B′ at different stimulus intensity levels. Incidentally, in S130, a non-linear response compression is performed using a variable FL obtained based on the luminance LA of the adaptation visual field. Next, the following processes are performed to find correlation with appearance.

In S140, red-green and yellow-blue opponent color responses ab are determined from R′aG′aB′a. In S150, the hue H is determined from the opponent color responses ab and an eccentricity factor. Also, in S190, a background induction factor n is determined from Yω and the background's relative luminance Yb. Furthermore, achromatic color responses A and Aω of both specimen and white are determined using the background induction factor n. In S151, the lightness J is determined based on a factor z which in turn is determined from the background induction factor n and lightness contrast factor FLL as well as on A, Aω, and the environmental influence constant c. In S153, saturation S is determined from the chromatic induction factor Nc. In S152, the chroma C is determined from the saturation S and lightness J. In S154, the luminance Q is determined from the lightness J and achromatic color response Aω. In S1551 the colorfulness M is determined from the variable FL-and environmental influence constant c.

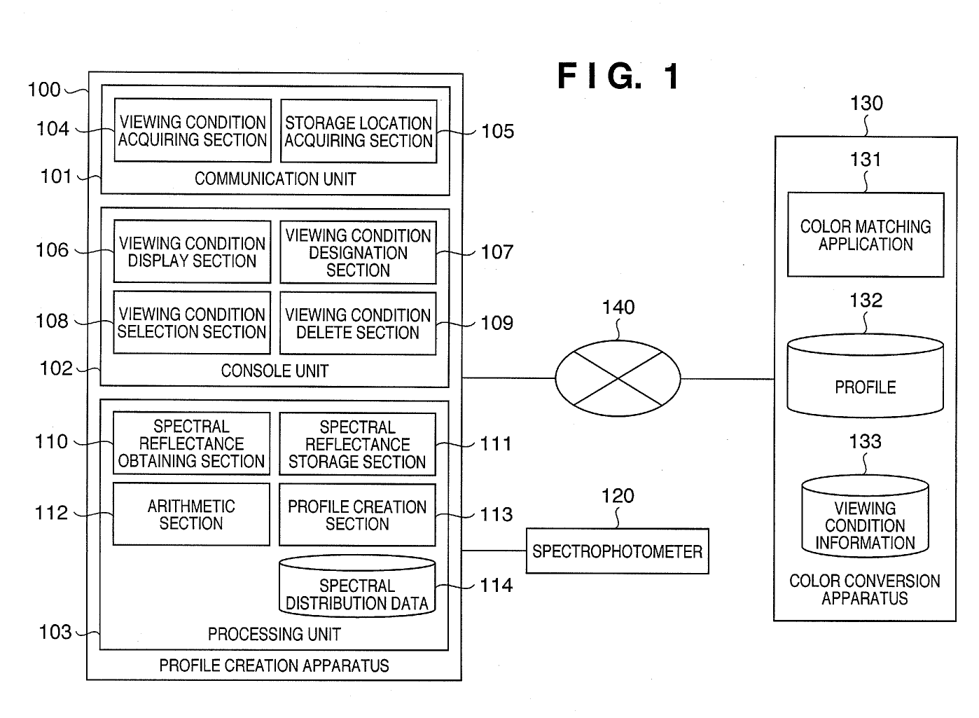

FIG. 1 is a block diagram showing an example of functional configuration of an image processing apparatus (profile creation apparatus and color conversion apparatus) according to an embodiment of the present invention.

In FIG. 1, reference numeral 100 denotes a profile creation apparatus, reference numeral 120 denotes a spectrophotometer, reference numeral 130 denotes a color conversion apparatus, and reference numeral 140 denotes a network. The profile creation apparatus 100 is connected with the color conversion apparatus 130 via the network 140. Also, the profile creation apparatus 100 is connected with the spectrophotometer 120. It creates a profile by acquiring spectral data measured by the spectrophotometer 120.

The profile creation apparatus 100 mainly comprises modules: a communication unit 101, console unit 102, and processing unit 103. The communication unit 101 has a viewing condition acquiring section 104 and storage location acquiring section 105. It acquires information needed to create a profile from the color conversion apparatus 130. The viewing condition acquiring section 104 acquires viewing condition information 133 from the color conversion apparatus 130. The storage location acquiring section 105 acquires a storing location for the created profile. The storing location is determined based on a storing location of a profile 132 acquired from the color conversion apparatus 130.

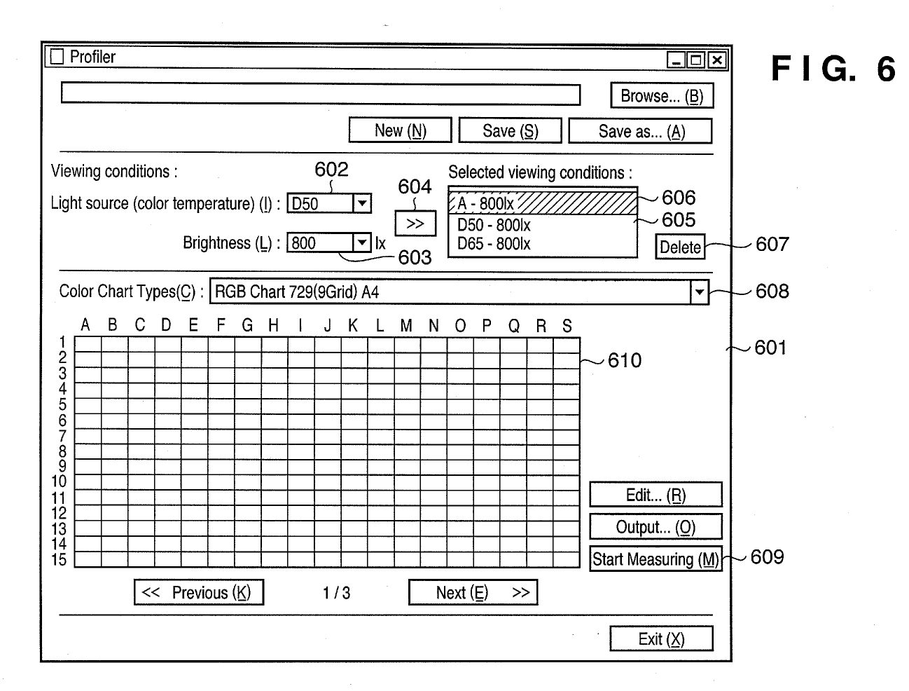

The console unit 102 has a viewing condition display section 106, viewing condition designation section 107, viewing condition selection section 108, and viewing condition delete section 109. The unit 102 controls a user interface related to viewing condition information. The viewing condition display section 106 displays the viewing condition information 133 acquired by the viewing condition acquiring section 104 on the user interface. The viewing condition designation section 107 allows a user to specify desired viewing conditions via the user interface. The viewing condition selection section 108 allows a user to select a desired set of viewing conditions from multiple sets of viewing conditions via the user interface. The viewing condition delete section 109 deletes a set of viewing conditions selected by a user via the viewing condition selection section 108. The modules 106 to 109 will be described later with reference to FIG. 6.

The processing unit 103 is a module which takes charge of a profile creation process. It has a spectral reflectance obtaining section 110, spectral reflectance storage section 111, arithmetic section 112, and profile creation section 113. The spectral reflectance obtaining section 110 obtains spectral reflectance data by measuring the color of each color chip with the spectrophotometer 120. The color chips are represented by a color chart such as 610 in FIG. 6. Color patches of different colors are printed in different cells of the chart. The spectral reflectance data of each color thus obtained is stored in the spectral reflectance storage section 111. The arithmetic section 112 performs arithmetic operations using Equation (1) described later, based on the spectral reflectance data of each color measured under a light source whose profile is to be created as well as on spectral distribution data of the light source, where the spectral reflectance data is measured by the spectrophotometer 120 and stored in the spectral reflectance storage section 111 while the spectral distribution data is stored in as spectral distribution data 114. The XYZ values of the color of each color chip are determined under the viewing conditions for which the profile is created, based on the arithmetic operations.

Based on the XYZ values for the color of each color chip determined by the arithmetic section 112 as well as on the viewing condition information, the profile creation section 113 creates a profile dependent on the viewing conditions. The profile created by the profile creation section 113 is stored in a storing location acquired by the storing location acquiring section 105. The spectral distribution data 114 is used as spectral distribution data of the light source under the viewing conditions when the XYZ values are determined by the arithmetic section 112.

The color conversion apparatus 130 has a color matching application 131, the profile 132, and the viewing condition information 133.

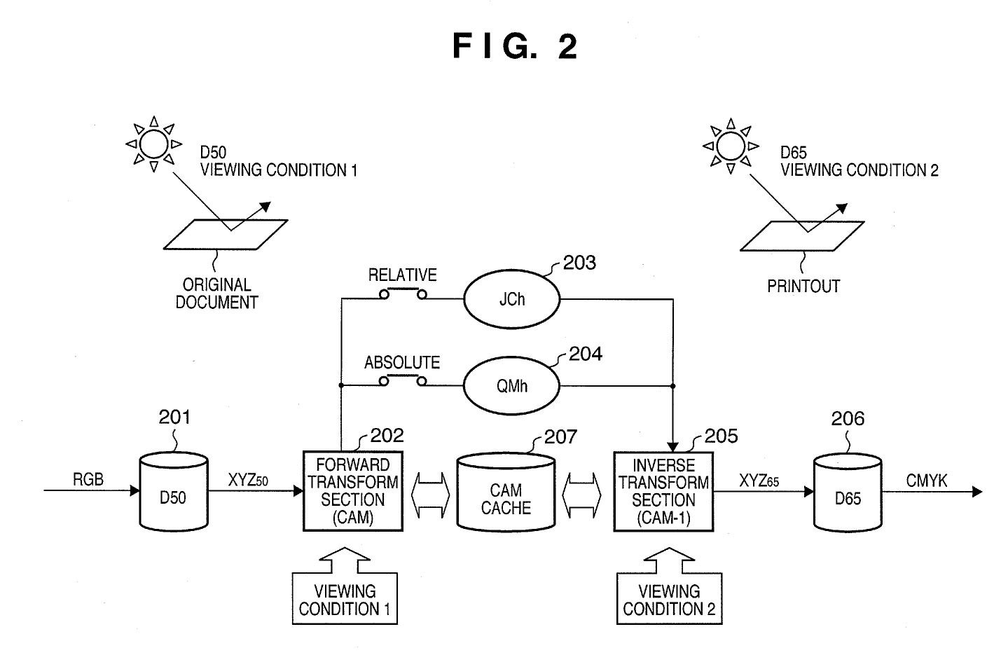

FIG. 2 is a conceptual diagram illustrating a concept of a color management system according to this embodiment.

In FIG. 2, reference numeral 201 denotes a transformation matrix or conversion lookup table (LUT) used to convert data dependent on an input device into device-independent color space data (XYZ50) which is based on a white point reference of ambient light (viewing condition 1) on the input side. A conversion process is performed according to the ambient light (D50) on the input side. A forward transform section (CAM) 202 of the color appearance model transforms data obtained from the conversion LUT 201 into a human color perception space JCh or QMh. JCh (or JCH) 203 is a color perception space relative to reference white of the ambient light. QMh (or QMH) 204 is an absolute color perception space whose size varies with the illuminance level. An inverse transform section 205 of the color appearance model transforms data in the human color perception space JCh or QMh into device-independent color space data (XYZ65) which is based on a white point reference of ambient light (D65) (viewing condition 2) on the output side. A conversion LUT 206 converts the data obtained from the inverse transform section 205 into color space data dependent on an output device.

Generally, the white point of ambient light under viewing conditions differs from the white point of a standard source obtained by measuring color chips such as color targets or color patches. For example, a standard light source used for color measurement is D50 or D65. However, the ambient light under which an image is actually viewed is not necessarily D50 or D65. Specifically, the ambient light is often constituted of illuminating light from an incandescent lamp or fluorescent lamp or a mixture of illuminating light and sunlight. Although it is assumed herein for simplicity of explanation that light source characteristics of ambient light in viewing conditions are D50, D65, and D93, actually, the white point is set at the XYZ values of a white point on a medium (such as paper).

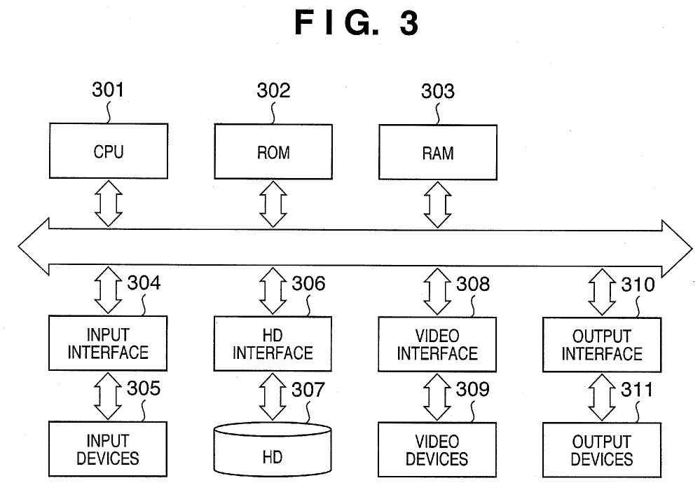

A CAM cache 207 stores pixel-by-pixel conversion results from the forward transform section (CAM) 202 and an inverse transform section 205 of the color appearance model for reuse. Results of conversion from XYZ to JCH are always the same under the same viewing conditions, and thus results of calculation from XYZ to JCH are stored in the CAM cache 207 on a pixel-by-pixel basis. The CAM cache 207, for example, consists of a forward transform hash table which uses XYZ values as keys and JCH values as values and an inverse transform hash table which uses JCH values as keys and XYZ values as values. When converting an XYZ value into a JCH value, the forward transform section 202 checks the CAM cache 207. If there is a hit, the forward transform section 202 uses the given JCH value, but if there is no hit, the forward transform section 202 determines a JCH value by calculation. Data stored in the CAM cache 207 can be used permanently if saved in an external storage device (HD 307)(FIG. 3). Also, the forward transformed results stored in the CAM cache 207 can be used for an inverse transform in the inverse transform section 205 if used under the same viewing conditions. Conversely, the inverse transformed results stored in the CAM cache 207 can be used for a forward transform in the forward transform section 202. Incidentally, the CAM cache 207 may be implemented using a mechanism other than a hash table.

FIG. 3 is a block diagram illustrating a hardware configuration of the profile creation apparatus 100 and color conversion apparatus 130 according to the embodiment of the present invention. The apparatus may be implemented by a general-purpose computer such as a personal computer supplied with software which implements the functions shown in FIG. 2. In that case, the software which implements the functions of this embodiment may be contained in an OS (operating system) of the computer or, for example, driver software of an input/output device apart from the OS. Alternatively, the profile creation apparatus 100 and color conversion apparatus 130 may be implemented as a single unit with the hardware configuration shown in FIG. 3.

In FIG. 3, a CPU 301 controls the entire apparatus according to programs stored in a ROM 302 and programs loaded on a RAM 303. The RAM 303 provides a working memory to temporarily store various data during control operation by the CPU 301. Also, the RAM 303 is loaded with application programs and the OS installed on a HD 307 when they are executed. In this way, the CPU 301 executes various processes including the processes related to color matching described above and takes charge of operation of the entire apparatus. An input interface 304 controls interface with input devices 305 such as a keyboard and a pointing device. A hard disk interface 306 controls data writes into the HD 307 and data reads from the HD 307. A video interface 308 controls interface with video devices 309 such as a display. An output interface 310 controls data output to an output devices 311 such as a printer.

In addition to the keyboard and pointing device described above, the input devices 305 relevant to this embodiment include photographic devices such as a digital still camera and digital video camera as well as image input devices such as an image scanner and film scanner. On the other hand, the output device 311 may include color monitors such as a CRT and LCD as well as image output devices such as a color printer and film recorder.

Regarding the interfaces, general-purpose interfaces can be used. Available interfaces include, for example, serial interfaces such as RS232C, RS422, USB 1.0/2.0, and IEEE1394 as well as parallel interfaces such as SCSI, GPIB, and centronics, depending on applications. Although input/output profiles for color matching are stored in the HD 307, they may be stored not only in a hard disk, but also in an optical disk such as MO.

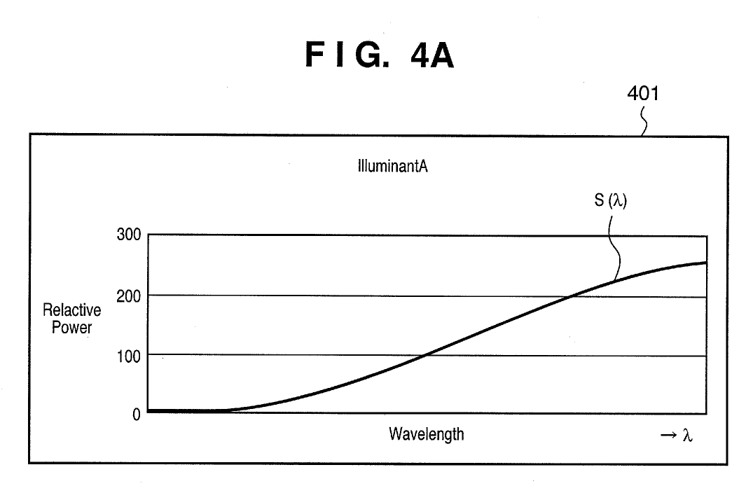

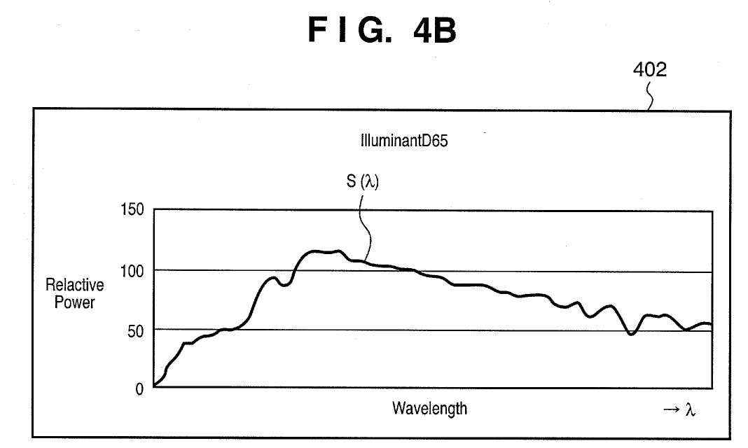

FIGS. 4A and 4B are diagrams showing spectral distributions of standard light sources.

FIG. 4A shows a spectral distribution of a light source A while FIG. 4B shows a spectral distribution of a D65 light source. Suppose a spectral distribution of a light source is S(λ), color matching functions in an XYZ color system are x(λ), y(λ), and z(λ), and spectral reflectance data of each color is R(λ). It is known that the XYZ values of colors under a specific light source can be derived using the following relational expression.
X=K∫S(λ)x(λ)R(λ)dλ
Y=K∫S(λ)y(λ)R(λ)dλ
Z=K∫S(λ)z(λ)R(λ)dλ
K=100/{S(λ)y(λ)R(λ)dλ} Equation (1)
where ∫ indicates the integral from 380 to 780 of λ; S(λ) indicates a spectral distribution of a light source used to display colors; x(λ), y(λ), and z(λ) indicate color matching functions in the XYZ color system; and R(λ) indicates a spectral reflectance factor.

The arithmetic section 112 calculates the XYZ values of a color chip of each color under the light source in specified viewing conditions using Equation (1).

An example of color matching using an input/output profile will be described below.

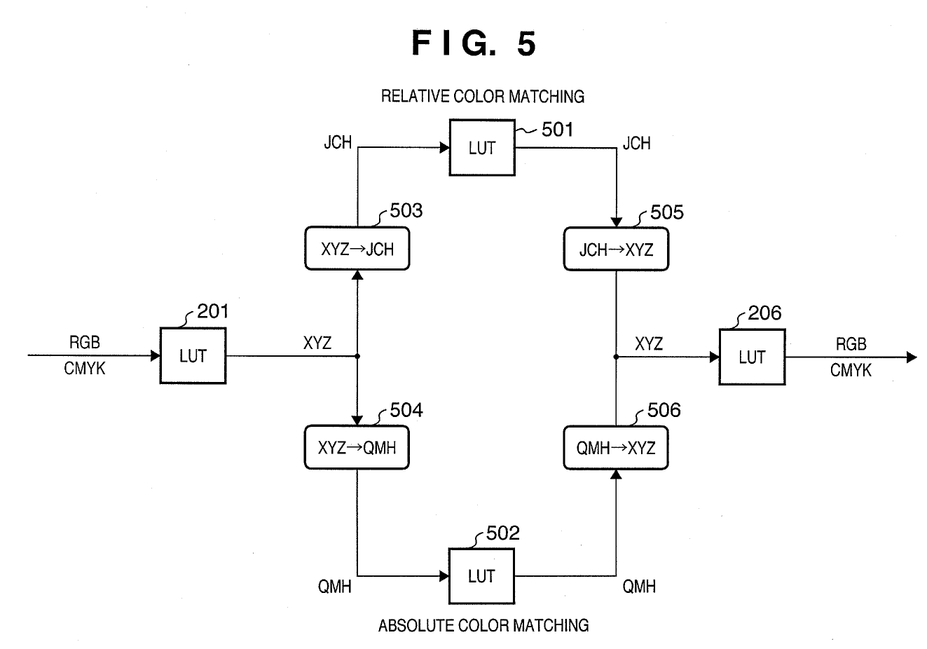

FIG. 5 is a diagram showing a concept of a color matching process.

A conversion LUT 201 is a conversion lookup table created under viewing condition 1. It corresponds to the LUT 201 in FIG. 2. A LUT 501 is a lookup table created in the JCH color space. A LUT 502 is a lookup table created in the QMH color space. Reference numeral 206 denotes a conversion lookup table created under viewing condition 2. It corresponds to the LUT 206 in FIG. 2.

An RGB or CMYK color signal is converted from a color signal of an input device into a device-independent color signal (XYZ signal) under viewing condition 1 by means of the LUT 201. The XYZ signal is converted into human perception signals JCH and QMH under viewing condition 1 (white point, illuminance level, ambient light condition, etc. of a D50 light source) by forward transform sections 503 and 504 of a color appearance model, respectively. The JCH space is selected in the case of relative color matching and the QMH space is selected in the case of absolute color matching. The color perception signals JCH and QMH are compressed so as to fall within the reproducible color gamut of an output device, based on the LUT 501 and LUT 502, respectively. The color perception signals JCH and QMH subjected to color space compression so as to fall within the reproducible color gamut of the output device are converted into a device-independent color signal (XYZ signal) under viewing condition 2 (white point, illuminance level, ambient light condition, etc. of a D65 light source) by inverse transform sections 505 and 506 of the color appearance model, respectively. The XYZ signal is converted, based on the LUT 206, into a color signal (RGB or CMYK signal) dependent on the output device under viewing condition 2. The LUT 206 is a conversion lookup table created based on viewing condition 2.

The RGB or CMYK signal obtained through the above process is sent to the output device (printer), on which a color image corresponding to the color signal is printed. The printed matter, when viewed under viewing condition 2, should appear in the same color as the original document viewed under viewing condition 1.

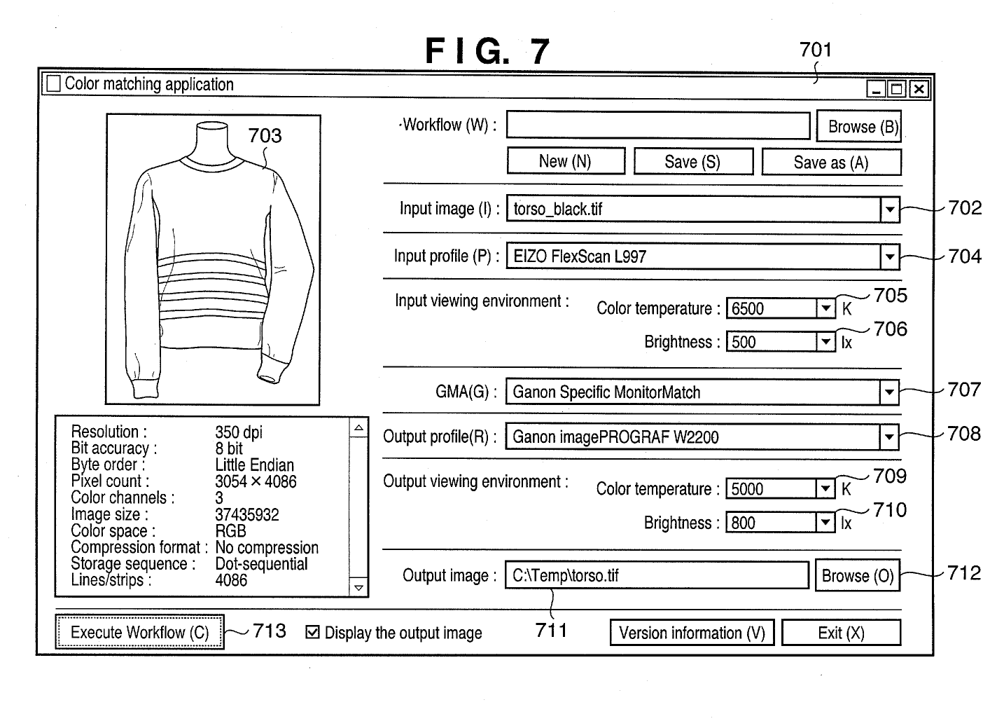

Next, user interfaces of the profile creation apparatus 100 according to this embodiment will be described with reference to FIGS. 6 and 7.

FIG. 6 is a diagram showing an example of a user interface of the profile creation apparatus 100 according to this embodiment. The display example is presented in a display section of the output devices 311.

Reference numeral 601 denotes a dialog box which is a main window of the profile creation apparatus 100. A user interface is displayed on the dialog box 601 to allow a user to specify various settings and processes. Reference numeral 602 denotes a light source (or color temperature) selection list box—a piece of viewing condition information—which allows the user to select a standard light source from among light source A, light source B, light source C, D50 light source, D55 light source, D65 light source, D75 light source, and the like. The list box 602 also allows the user to set any color temperature by entering, for example, “3000K” in Kelvins. Reference numeral 603 denotes another piece of viewing condition information—a box for use to enter brightness of the light source. The box allows the user to select a relatively frequently used brightness from among “250,” “400,” “600,” “800,” “1000,” etc. (luxes(lx)) as well as enter any desired brightness. Reference numeral 604 denotes a button for use to add the viewing conditions selected or entered in the boxes 602 and 603 to a list. The above items belong to the viewing condition designation section 107 according to this embodiment. Reference numeral 605 denotes a list (which corresponds to the viewing condition display section 106) of viewing conditions for which a profile will be created. In this example, “light source A—800 lx,” “D50 light source—800 lx,” and “D65 light source—800 lx,” are listed. Reference numeral 606 denotes a set of viewing conditions selected from the viewing condition list 605. The selected set of viewing conditions can be changed by moving a cursor with keyboard cursor keys or a pointing device (this corresponds to the viewing condition selection section 108). Pressing a delete key 607 deletes the selected set of viewing conditions. This corresponds to the viewing condition delete section 109 according to this embodiment. Reference numeral 608 denotes a list section for use to select a type of color chip for color measurement. The color chips thus selected are displayed in the form of a color chart such as shown in 610.

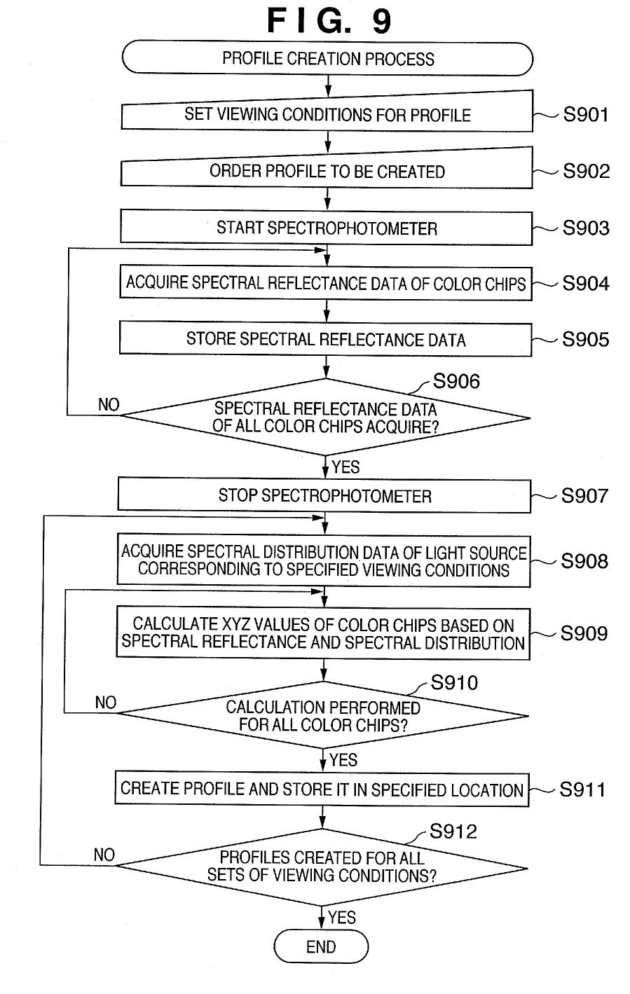

When a Start Measuring button 609 is pressed in this state, the spectrophotometer 120 starts up and starts measuring the colors of the color chips. Consequently, the colors of the color chips (“RGB Chart 729 (9Grid) A4,” in the example of FIG. 6),are read and resulting spectral reflectance data is stored in the spectral reflectance storage section 111. When the reading of the colors is completed, the completion of the color measurements is indicated in the cells of the chart 610 in FIG. 6. Once all the colors are measured and their data is stored in the spectral reflectance storage section 111, a process of creating a profile is commenced under each sets of viewing conditions in the observed condition list 605. In the example of FIG. 6, three profiles are specified to be created under the conditions: “light source A—800 lx,” “D50 light source—800 lx,” and “D65 light source—800 lx.” Thus, spectral distribution of the light source in each set of viewing conditions is read out of the spectral distribution data 114 and a profile of the light source is created, based on the spectral distribution data and on the spectral reflectance data of each color in the spectral reflectance storage section 111. This process will be described in detail with reference to a flowchart in FIG. 9.

FIG. 7 is a diagram showing an example of a user interface displayed by the color matching application 131 on the color conversion apparatus 130 according to the embodiment.

Reference numeral 701 denotes a dialog box which is a main window of the color matching application 131. A user interface is displayed on the dialog box 701 to allow a user to specify various settings and processes. Reference numeral 702 denotes a list box for use to select an input image. The list box 702 lists images for color conversion stored in a predetermined location. Reference numeral 703 denotes a preview display of the input image. The input image selected in the list box 702 is displayed in a reduced format. Reference numeral 704 denotes a list box for use to select an input profile. The list box 704 allows a user to select a desired input profile from a list of profiles with a description of input device characteristics. Reference numeral 705 denotes a list box for use to select the color temperature of the light source—one of the viewing conditions on the input side. Reference numeral 706 denotes a list box for use to select the brightness of the light source—one of the viewing conditions on the input side.

Reference numeral 707 denotes a GMA (Gamut Mapping Algorithm) selection list box. The list box 707 is used to select a method for mapping (gamut mapping) from a color gamut of an input device to a color gamut of an output device. The GMA is changed according to its application in color conversion. Reference numeral 708 denotes a list box for use to select an output profile. The list box 708 allows a user to select a desired output profile from a list of profiles with a description of output device characteristics. Reference numeral 709 denotes a list box for use to select the color temperature of the light source—one of the viewing conditions on the output side. Reference numeral 710 denotes a list box for use to select the brightness of the light source—one of the viewing conditions on the output side. Reference numeral 711 denotes an area for use to specify an output image name and numeral 712 denotes a Browse button for use to specify an output image. Pressing the Browse button 712 brings up an input dialog box, showing a standard file name and allowing a user to specify a file in which the user wants to save the image after color conversion. Reference numeral 713 denotes a workflow execution button which is used to actually perform color conversion for the input image according to the information set in the items 702 to 711. The results of conversion thus produced are saved with the file name in a directory specified in the area 711.

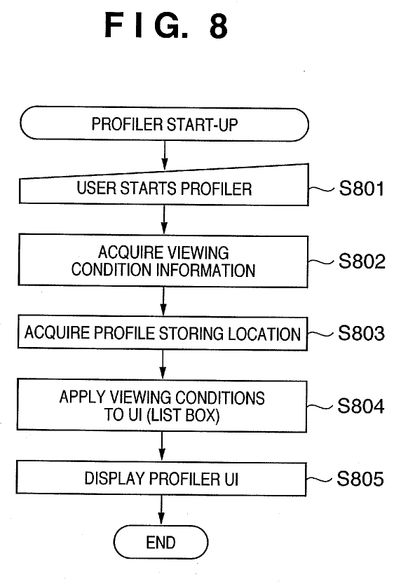

Next, processing procedures according to the embodiment of the present invention will be described with reference to the flowcharts in FIGS. 8 and 9.

FIG. 8 is a flowchart illustrating a start-up process of the profile creation apparatus 100 (hereinafter referred to as the profiler) according to this embodiment. A program which performs this process is stored in the ROM 302 or RAM 303 at runtime and is executed under the control of the CPU 301.

In Step S801, the process is started as a user starts the profiler. In Step S802, information about viewing conditions (viewing condition information 133) is acquired. According to this embodiment, the viewing condition information 133 is stored in the color conversion apparatus 130 connected via the network 140. In Step S803, the storing location of the created profile 132 is acquired. In this embodiment, the created profile is stored in the profile 132 of the color conversion apparatus 130, and thus one of storage regions in the profile 132 is used as the storing location. In Step S804, the viewing condition information 133 acquired in Step S802 is applied to the user interface. According to this embodiment, a light source (color temperature) 602 and brightness 603 are specified as viewing conditions on the user interface. Finally, in Step S805, a profiler setting dialog box such as shown in FIG. 6 is displayed to finish the profiler start-up process.

FIG. 9 is a flowchart illustrating a profile creation process by the profiler 100 according to this embodiment. A program which performs this process is stored in the ROM 302 or RAM 303 at runtime and is executed under the control of the CPU 301.

In Step S901, user-specified viewing conditions are set for the profile to be created. Specifically, as the user specifies a desired light source (color temperature) 602 and brightness 603 on the user interface shown in FIG. 6, they can be set as viewing conditions (606) for the profile to be created. A single or multiple sets of viewing conditions can be specified for the profile to be created. Even if multiple sets of viewing conditions are specified, profiles for the multiple sets of viewing conditions can be created in a single session of color measurements. In Step S902, as the user presses “Start Measuring” 609, the creation of profile is ordered to be created. In Step S903, the spectrophotometer 120 is started.

In Step S904, spectral reflectance data on the colors of the color chips specified in 608 in FIG. 6 is acquired from the spectrophotometer 120. In Step S905, the spectral reflectance data acquired in Step S904 is stored in the spectral reflectance storage section 111. In Step S906, it is determined whether all the color patches of the color chips have been read. If all the color patches have not been read, the process returns to Step S904 to read the next patch. After that, the process advances to Step S905. If it is determined in Step S906 that spectral reflectance data on all the colors of the color chips have been inputted, the process advances to Step S907 to stop color measurements with the spectrophotometer 120, and then advances to Step S908.

In Step S908, the spectral distribution data of the light source corresponding to one set of the viewing conditions specified in Step S901 is acquired from the spectral distribution data 114. In Step S909, based on the spectral reflectance data of the color of each color chip stored in the spectral reflectance storage section 111 in Step S905 and the spectral distribution data of the light source acquired in Step S908, the XYZ values of the color of each color chip are calculated using Equation (1). In Step S910, it is determined whether arithmetic processing has been performed on the colors of all the color chips. If not, the process returns to Step S909 to perform arithmetic processing on the next color. If it is determined in Step S910 that arithmetic processing has been performed on the colors of all the color chips, the process advances to Step S911 to create the profile based on results of the arithmetic processing. The created profile is saved in the profile storing location specified in Step S803 in FIG. 8. Finally, in Step S912, it is determined whether profiles have been created under all the sets of viewing conditions specified in Step S901 (e.g., “light source A—800 lx,” “D50 light source—800 lx,” and “D65 light source—800 lx,” in the example of FIG. 6). If not, the process returns to Step S908 to create a profile under the next sets of viewing conditions. When profiles have been created under all the sets of viewing conditions, the profile creation process comes to an end.

Although in the above embodiment, the profile creation apparatus 100 and color conversion apparatus 130 are connected with each other via the network 140, needless to say, they may be implemented on the same computer equipment without any intermediary network.

Also, although in the above embodiment, the spectral distribution data is stored in the profile creation apparatus 100, the data may be contained in the viewing condition information 133 in the color conversion apparatus 130 so that it can be acquired by the viewing condition acquiring section 104. Alternatively, the data may be stored in a server connected via another network.

Furthermore, the above embodiment has been described by citing a color matching process between an original document viewed under viewing condition 1 and printing results viewed under viewing condition 2. However, the present invention is not limited to this. For example, the present invention is also applicable to a color matching process between an original document viewed under viewing condition 3 and display on a monitor device viewed under viewing condition 4.

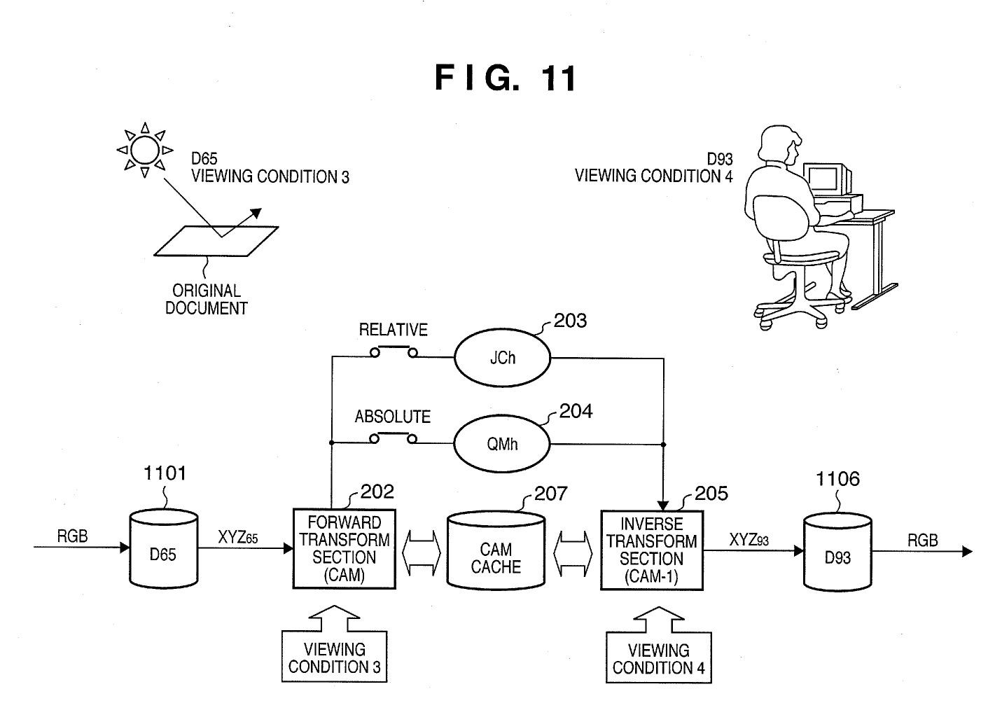

FIG. 11 is a conceptual diagram illustrating a concept of a color management system according to a variation of this embodiment, wherein the same components as those in FIG. 2 are denoted by the same reference numerals as the corresponding components in FIG. 2.

In FIG. 11, reference numeral 1101 denotes a transformation matrix or conversion lookup table (LUT) used to convert data dependent on an input device into device-independent color space data which is based on a white point reference of ambient light (D65) on the input side. A forward transform section (CAM) 202 of the color appearance model transforms data obtained from the conversion LUT 1101 into a human color perception space JCh or QMh. JCh (or JCH) 203 is a color perception space relative to reference white of the ambient light. QMh (or QMH) 204 is an absolute color perception space whose size varies with the illuminance level. An inverse transform section 205 of the color appearance model transforms data in the human color perception space JCh or QMh into device-independent color space data which is based on a white point reference of ambient light on the output side. A conversion LUT 1106 converts the data obtained from an inverse transform section 205 into color space data dependent on an output device.

The standard source actually used here for color measurements is D65. On the other hand, light source characteristics of the ambient light in the viewing conditions under which the image is observed is D93.

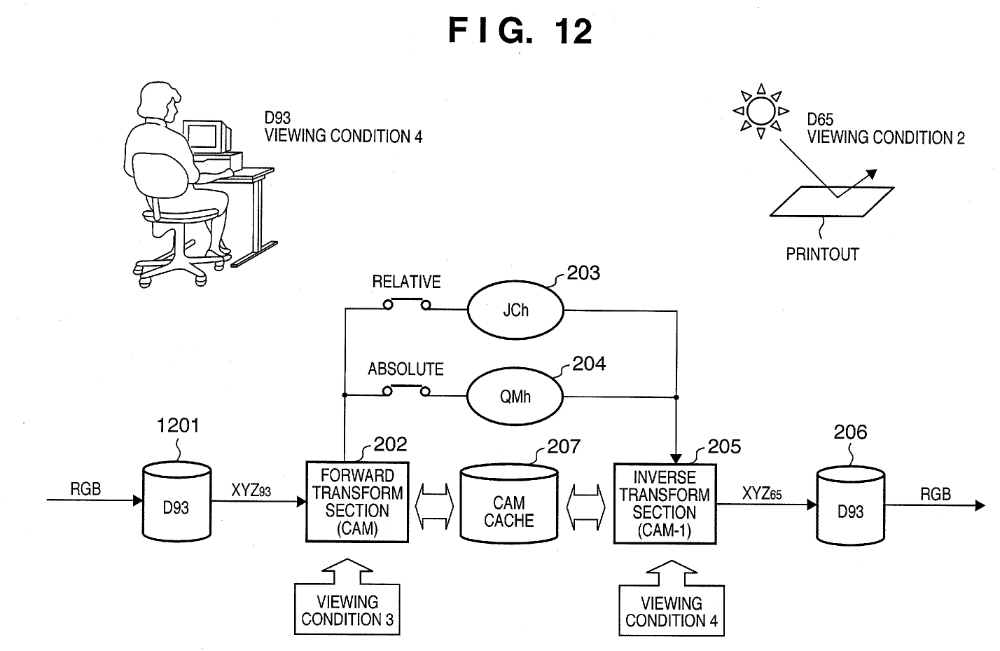

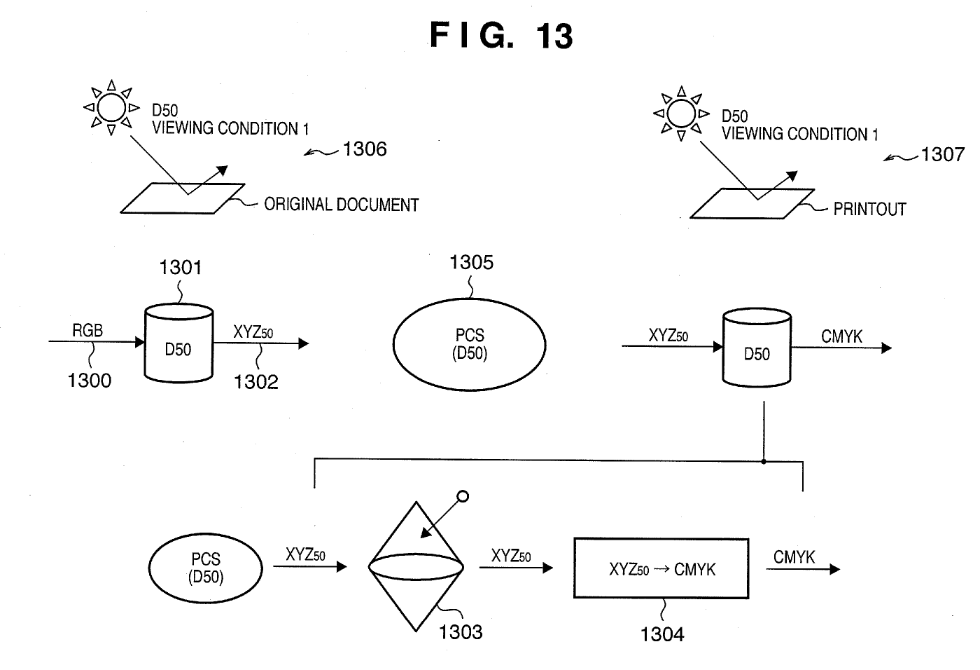

FIG. 12 is a conceptual diagram illustrating a concept of a color management system according to another variation of this embodiment, wherein the same components as those in FIG. 2 are denoted by the same reference numerals as the corresponding components in FIG. 2.

Shown here is an example where the present invention is applied to a color matching process between a monitor device viewed under viewing condition 4 (D93) and printed matter viewed under viewing condition 2 (D65).

In FIG. 12, a conversion LUT 1201 converts data dependent on an input device into device-independent color space data which is based on a white point reference of ambient light (D65) on the input side. A conversion LUT 206 converts the data obtained from an inverse transform section 205 into color space data which corresponds to the viewing condition (D65).

Although a light source (color temperature) and brightness have been used as the viewing conditions according to this embodiment, needless to say, any parameter may be used as long as the profile to be created depends on it.

Although in this embodiment, spectral reflectance data is acquired by reading specified color chips with the spectrophotometer 120, the present invention is not limited to this and is applicable to cases where spectral reflectance data on predetermined color chips is prestored in the spectral reflectance storage section 111.

Needless to say, the computers to which the present invention is applied include personal computers, portable terminals including portable phones, image forming apparatus, and so on regardless of their form.

Needless to say, the object of the present invention can also be achieved by a storage medium containing software program code that implements the functions of the above embodiment; it is supplied to a system or apparatus, whose computer (or CPU or MPU) then reads the program code out of the storage medium and executes it. In that case, the program code itself read out of the storage medium will implement the functions of the above embodiment, and the storage medium which stores the program code will constitute the present invention. The storage medium for supplying the program code may be, for example, a floppy (registered trademark) disk, hard disk, optical disk, magneto-optical disk, CD-ROM, CD-R, magnetic tape, non-volatile memory card, ROM, DVD, or the like.

Also, the functions of the above embodiments may be implemented not only by the program code read out and executed by the computer, but also by part or all of the actual processing executed, in accordance with instructions from the program code, by an OS (operating system), etc. running on the computer.

Furthermore, it goes without saying that the functions of the above embodiment may also be implemented by part or all of the actual processing executed by a CPU or the like contained in a function expansion board inserted in the computer or a function expansion unit connected to the computer if the processing is performed in accordance with instructions from the program code that has been read out of the storage medium and written into memory on the function expansion board or unit.

When applying the present invention to the storage medium, the storage medium will contain program code which corresponds to the flowchart described above.

As described above, when creating a profile for color matching, this embodiment makes it possible to create profiles for multiple sets of viewing conditions in a single session of color measurements.

Also, data for multiple sets of viewing conditions can be included in a single profile.

Also, according to this embodiment, the viewing conditions selectable by the system can be reflected in the profile creation apparatus, and thus a profile to be created can always be specified according to the viewing conditions available to the system.

Also, according to this embodiment, by storing a profile in a profile storage location acquired from the system, it is possible to store a plurality of created profiles in any desired storage location determined in advance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Application No. 2005-264438 filed Sep. 12, 2005, which is hereby incorporated by reference herein in its entirety.

What is claimed is:

1. An image processing apparatus for creating a profile for color matching, comprising:
a viewing condition setting unit configured to set viewing conditions to which the profile is applied;
a spectral reflectance storage unit configured to store spectral reflectance data on each of a plurality of predetermined colors;
a spectral distribution storage unit configured to store spectral distribution data on a light source;
an arithmetic unit configured to determine XYZ values of each of the colors under the viewing conditions, based on the spectral distribution data of the light source under the viewing conditions set by said viewing condition setting unit as well as on the spectral reflectance data on each of the colors, the spectral distribution data being stored in said spectral distribution storage unit;
a profile creation unit configured to create a profile dependent on the viewing conditions, based on the XYZ values of the colors obtained by said arithmetic unit; and
a control unit configured to ensure that said arithmetic unit and said profile creation unit create a profile for each set of viewing conditions, in a case where multiple sets of viewing conditions are set by said viewing condition setting unit.

2. The image processing apparatus according to claim 1, further comprising a spectrum measuring unit configured to optically read color chips on which the plurality of predetermined colors are printed, and thereby acquiring spectral reflectance data on each of the colors, wherein said spectral reflectance storage unit stores the spectral reflectance data measured by said spectrum measuring unit.

3. The image processing apparatus according to claim 1, further comprising:
a setting unit configured to set color chips; and
a unit configured to acquire spectral reflectance data on each of a plurality of colors of the color chips set by the setting unit,
wherein said profile creation unit creates a profile, based on the spectral reflectance data on each of the plurality of colors of the color chips set by said setting unit.

4. The image processing apparatus according to claim 1, wherein in a case that multiple sets of viewing conditions are set by said viewing condition setting unit, said control unit creates the profile so as to accommodate the multiple sets of viewing conditions.

5. The image processing apparatus according to claim 1, wherein the viewing conditions include the type and brightness of a light source.

6. The image processing apparatus according to claim 1, wherein said viewing condition setting unit comprises:
a unit configured to acquire one or multiple pieces of viewing condition information out of multiple pieces of viewing condition information, and
a viewing condition display unit configured to display the acquired one or multiple pieces of viewing condition information;
wherein said viewing condition setting unit sets viewing conditions for the profile, in a case that the viewing conditions are specified from among the viewing conditions displayed by said viewing condition display unit.

7. The image processing apparatus according to claim 1, further comprising:
storage location setting unit configured to set a storage location of the profile created by said profile creation unit; and
a unit configured to store the profile in the storage location set by said storage location setting unit.

8. An image processing method for creating a profile for color matching, comprising:
a viewing condition setting step of setting viewing conditions to which the profile is applied;
an arithmetic step of determining XYZ values of each of a plurality of predetermined colors under the viewing conditions set in said viewing condition setting step, based on spectral reflectance data on each of the colors as well as on spectral distribution data on a light source under the viewing conditions;
a profile creation step of creating a profile dependent on the viewing conditions, based on the XYZ values of the colors obtained in said arithmetic step; and
a control step of causing said arithmetic step and said profile creation step to create a profile for each set of viewing conditions, in a case that multiple sets of viewing conditions are set in said viewing condition setting step.

9. The image processing method according to claim 8, further comprising a spectrum measuring step of optically reading color chips on which the plurality of predetermined colors are printed, and thereby acquiring spectral reflectance data on each of the colors, wherein the spectral reflectance data is measured in said spectrum measuring step.

10. The image processing method according to claim 8, further comprising:
a setting step of setting color chips; and
a step of acquiring spectral reflectance data on each of a plurality of colors of the color chips set in said setting step,
wherein said profile creation step creates a profile, based on the spectral reflectance data on each of the plurality of colors of the color chips set in said setting step.

11. The image processing method according to claim 8, wherein in a case that multiple sets of viewing conditions are set in said viewing condition setting step, said control step creates the profile so as to accommodate the multiple sets of viewing conditions.

12. The image processing method according to claim 8, wherein the viewing conditions include the type and brightness of a light source.

13. The image processing method according to claim 8, wherein said viewing condition setting step comprising:
a step of acquiring one or multiple pieces of viewing condition information out of multiple pieces of viewing condition information, and
a viewing condition display step of displaying the acquired one or multiple pieces of viewing condition information;
wherein said viewing condition setting step sets viewing conditions for the profile, in a case that the viewing conditions are specified from among the viewing conditions displayed in said viewing condition display step.

14. The image processing method according to claim 8, further comprising:
a storage location setting step of setting a storage location of the profile created in said profile creation step; and
a step of storing the profile in the storage location set in said storage location setting step.

15. A program which executes the image processing method according to claim 8.

16. A computer readable storage medium which contains the program according to claim 15.
